(19) United States
(12) Patent Application Publication
(10) Pub. No.: US 2014/0278595 A1
(43) Pub. Date: Sep. 18, 2014

(54) VENUE TICKET BUYBACK WITH SMART PRICING

(71) Applicant: John Raymond Werneke, Naperville, IL (US)

(72) Inventor: John Raymond Werneke, Naperville, IL (US)

(73) Assignee: Live Nation Entertainment, Inc., Beverly Hills, CA (US)

(21) Appl. No.: 13/836,638

(22) Filed: Mar. 15, 2013

(51) Int. Cl. G06Q 10/02

(52) U.S. Cl. CPC G06Q 10/02
USPC 705/5

(57) ABSTRACT

A venue ticket buyback system may facilitate repurchasing of venue tickets from ticketholders. An option for venue ticket buyback may be presented to a user. A user selection of the option for venue ticket buyback may be processed. An identification reference received from the user for a venue ticket may be processed. The identification reference for the venue ticket may be authenticated with ticket information. The user may be authenticated with authentication information. A buyback price for the venue ticket may be determined at least partially based on a profile of a potential buyer. The venue ticket may be repurchased at the buyback price on behalf of the potential buyer.

### BACKGROUND

The present disclosure relates in general to ticket sales and distribution, and, more specifically, but not by way of limitation, to venue ticket buyback with smart pricing.

In the world of ticket sales and distribution for live entertainment, it is not uncommon that, after someone buys tickets for an event, something comes up such that the ticketholder is no longer able to attend the event. The ticketholder is then faced with a dilemma, either try to resell the tickets or chalk the purchase up as a total loss, and give the tickets away or let them go unused.

When one wants to sell the tickets, the tickets may be posted for sale on various websites, or a broker may be contacted to negotiate. But trying to resell tickets can be a hassle to some. It can be time-intensive and frustrating. Many ticketholders just do not want to deal with all that is involved. Oftentimes, a ticketholder just wants out. And ticketholders often opt to just give the tickets away or not even bother with further dealing with the tickets anymore. But, a ticketholder may be willing to sell quickly at a discount, rather than spend time posting a ticket for sale, wondering if it will sell, checking back, managing pricing, carrying the risk that it will not sell, etc.

### SUMMARY

In one aspect, certain embodiments may facilitate a wholesale marketplace for venue tickets that may be based on venue ticket buyback. Certain embodiments may provide a platform facilitating venue ticket buyback. Venue ticket buyback may be instant, or substantially expedited such the transaction occurs within a short time frame. A ticket handling system may verify a ticket identifier, such as a bar code, and verify a ticketholder, which may expedite the buyback transaction. The buyback transaction may be performed with automated buying parameters. The automated buying parameters may be predefined so that buyback may be effected automatically on behalf of potential buyer. Such buying parameters may be implemented with a buyer profile, and may implement a smart pricing strategy. Any suitable pricing strategies may be employed, including, without limitation, defining price thresholds, prices dependent on discounts based on face values of tickets, prices dependent on discounts based on current market values of tickets, time frame thresholds, prices dependent on time left before an event, prices dependent on market information, prices dependent on event and/or venue, prices dependent on risk that tickets cannot be resold, prices dependent on intended redirection of the tickets such as for charity, and/or the like. Certain embodiments may provide for one or more smart pricing strategies that are dynamic, with some embodiments allowing for real time or expedited price determinations. In some embodiments, potential buyers may be expeditiously contacted to obtain buyback prices. Certain embodiments may provide for facilitating want-to-buy requests of potential buyers. Want-to-buy requests could be translated into buyback options presented to ticketholders.

In another aspect, a venue ticket buyback system to facilitate repurchasing of venue tickets from ticketholders may be provided. One or more network interfaces may be configured to provide access to a network. One or more processors may be coupled to the one or more network interfaces to enable a user to select an option for venue ticket buyback through the network. The one or more processors may be to execute instructions to perform one or more of the following. The option for venue ticket buyback may be presented to the user with at least one of the one or more network interfaces. A user selection of the option for venue ticket buyback may be processed. An identification reference for a venue ticket may be processed. The identification reference may be received from the user. The identification reference for the venue ticket may be authenticated with ticket information accessible to the one or more processors. The user may be authenticated with authentication information accessible to the one or more processors. A buyback price for the venue ticket may be determined at least partially based on a profile of a potential buyer. The venue ticket may be repurchased at the buyback price on behalf of the potential buyer. One or more storage media may be coupled to the one or more processors to retain the instructions.

In yet another aspect, a method of facilitating repurchasing of venue tickets from ticketholders may be provided. An option for venue ticket buyback to a user with a network interface may be presented. A user selection of the option for venue ticket buyback may be processed. An identification reference for a venue ticket may be processed. The identification reference may be received from the user. The identification reference for the venue ticket may be authenticated with ticket information. The user may be authenticated with authentication information. A buyback price for the venue ticket may be determined at least partially based on a profile of a potential buyer. The venue ticket may be repurchased at the buyback price on behalf of the potential buyer.

In still another aspect, a non-transitory machine-readable medium having machine-readable instructions thereon which, when executed by one or more computers or other processing devices, implements a method of facilitating repurchasing of venue tickets from ticketholders, may be provided. An option for venue ticket buyback to a user with a network interface may be presented. A user selection of the option for venue ticket buyback may be processed. An identification reference for a venue ticket may be processed. The identification reference may be received from the user. The identification reference for the venue ticket may be authenticated with ticket information. The user may be authenticated with authentication information. A buyback price for the venue ticket may be determined at least partially based on a profile of a potential buyer. The venue ticket may be repurchased at the buyback price on behalf of the potential buyer.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures.

FIG. 1 depicts a high-level block diagram of a system, in accordance with certain embodiments of the present disclosure.

FIG. 2 depicts a high-level block diagram of a ticket information handling system, in accordance with certain embodiments of the present disclosure.

FIG. 3 depicts a illustrating certain aspects of a ticket information handling system, in accordance with certain embodiments of the present disclosure.

FIG. 4 illustrates a process for facilitating ticket purchase via a ticket platform, in accordance with certain embodiments of the present disclosure.

FIG. 5 is a block diagram that illustrates certain aspects of a wholesale ticket marketplace management lifecycle, in accordance with certain embodiments of the present disclosure.

FIG. 6 illustrates a process for facilitating ticket buyback via a ticket platform, in accordance with certain embodiments of the present disclosure

FIG. 7 illustrates a process for facilitating a request for tickets via ticket buyback with the ticket platform, in accordance with certain embodiments of the present disclosure.

FIG. 8 illustrates another process for facilitating ticket buyback via a ticket platform, in accordance with certain embodiments of the present disclosure.

FIG. 9 is a diagram that illustrates certain aspects of a notification hierarchy, in accordance with certain embodiments of the present disclosure.

FIG. 10 depicts a block diagram of an embodiment of a computer system, in accordance with certain embodiments of the present disclosure.

FIG. 11 depicts a block diagram of an embodiment of a special-purpose computer system, in accordance with certain embodiments of the present disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment of the disclosure. It should be understood that various changes may be made in the function and arrangement of elements without departing from the spirit and scope of the disclosure as set forth in the appended claims.

Specific details are given in the following description to provide a thorough understanding of the embodiments. However, it will be understood by one of ordinary skill in the art that the embodiments maybe practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Certain embodiments according to the present may alleviate the frustration that would otherwise oftentimes involve a tedious, time-consuming manual process involving steps such as logging in, listing tickets for sale, setting a price, repeatedly checking on the status of the listing, checking on comparable listings, repeatedly watching the time left till the event, changing the listing price, perhaps multiple times until the tickets are sold, if at all, and essentially becoming a ticket broker by necessity. Certain embodiments may utilize unique aspects of venue tickets to provide various benefits to ticketholders, venues, brokers, and/or others. Certain embodiments may help maximize venue utilization. Certain embodiments may lead to venues having seats filled with new fans that might buy a season pass next year. The new fans can provide revenue through use of the concessions with no additional costs, as the security, lighting, etc. are already fixed regardless of attendance. In some cases, a ticketholder may be stuck with tickets because a third party may have placed a constraint on reselling the tickets for less than face value. However, with certain embodiments, a ticketholder may be provided with the opportunity to resell tickets with a quick sale at a discounted price.

Certain embodiments may facilitate a wholesale marketplace for venue tickets. The wholesale marketplace may be driven by ticket buyback in some embodiments. Payment could be instant or expedited based at least in part on system verification of ticket legitimacy. A ticket handling system may verify a ticket identifier, such as a bar code, and verify an original purchaser.

Certain embodiments may provide for instant ticket buyback with a smart pricing strategy. Certain embodiments may provide for one or more smart pricing strategies that are dynamic, with some embodiments providing dynamic pricing along with buyback features. Certain embodiments may provide for buyback features that include options for instant buyback of a ticket, at a discount to current market prices, for resale. A ticket may be purchased by any of various parties, such as the corresponding venue, another fan, a broker, another interested party, or the ticket platform. User interfaces may be provided for any one or combination of the parties. In some embodiments, a buyer may be able to specify a price that the buyer is willing to pay. In some embodiments, smart pricing strategy tools may be provided to a buyer as well.

Certain embodiments may provide a platform facilitating venue ticket buyback. Certain embodiments may display ticket sale information for viewing by sellers, potential sellers, buyers, and/or potential buyers. Certain embodiments may display ticket sale information in real time. Certain embodiments may provide a system configured to alert sellers, potential sellers, buyers, and/or potential buyers regarding events of interest. In some embodiments, a user may identify the ticket(s) for which buyback is sought. In some embodiments, the system may pre-identify the ticket(s) for which buyback is sought.

Various embodiments will now be discussed in greater detail with reference to the accompanying figures, beginning with FIG. 1.

FIG. 1 depicts a high-level block diagram of a system 100, in accordance with certain embodiments of the present disclosure. The system 100 allows transfer of information from and/or to one or more of a ticket information handling system 106, one or more ticketholders 102, one or more venues 108, one or more brokers 110, one or more other potential buyers 112, and/or one or more data sources 114. As depicted, ticketholders 102 may be communicatively coupled or couplable to a network 104 and the ticket information handling system 106 through one or more ticketholder interfaces 103. Venues 108 may be communicatively coupled or couplable to the network 104 and the ticket information handling system 106 through one or more venue interfaces 109. Brokers 110 may be communicatively coupled or couplable to the network 104 and the ticket information handling system 106 through one or more broker interfaces 110. Other potential buyers 112 may be communicatively coupled or couplable to the network 104 and the ticket information handling system 106 through one or more potential buyer interfaces 113.

The network 104 may be any suitable means to facilitate data transfer in the system 100. In various embodiments, the network 104 may be implemented with, without limitation, one or more of the Internet, a wide area network (WAN), a local area network (LAN), a wireless local area network (WLAN), a metropolitan area network (MAN), a cellular network, such as through 4G, 3G, GSM, etc., another wireless network, a gateway, a conventional telephone network, or any other appropriate architecture or system that facilitates the communication of signals, data, and/or message. The network 104 may transmit data using any suitable communication protocol. The network 104 and its various components may be implemented using hardware, software, and communications media such wires, optical fibers, microwaves, radio waves, and other electromagnetic and/or optical carriers; and/or any combination of the foregoing. The ticketholders 102, venues 108, brokers 110, other potential buyers 112, data sources 114, and/or ticket information handling system 106 may be communicatively coupled or couplable to the network 104 via any suitable communication paths that support the communication protocol(s) used in the various embodiments.

In various embodiments, the ticket information handling system 106 may include any device or set of devices configured to process, compute, organize, categorize, qualify, send, receive, retrieve, generate, convey, store, display, present, detect, handle, and/or use any form of information and/or data suitable for embodiments described herein. The ticket information handling system 106 could include a single computing device, a server, for example, or multiple computing devices, which may be implemented in or with a distributed computing and/or cloud computing environment with a plurality of servers and cloud-implemented resources. Thus, the ticket information handling system 106 may include one or more servers. The ticket information handling system 106 may include one or more processing resources communicatively coupled to one or more storage media, random access memory (RAM), read-only memory (ROM), and/or other types of memory. The ticket information handling system 106 may include any one or combination of various input and output (I/O) devices, network ports, and display devices.

The ticketholder(s) 102 may include, by way of example without limitation, an individual, a party, an organization, an institution, and/or another entity that has one or more tickets that may or may not be for sale. The tickets may in paper form, in other tangible form, and/or may correspond to an electronic record. The tickets may or may not have been purchased by the ticketholder(s) 102.

As used herein, in various embodiments, any one or combination of one or more the system 106, venues 108, brokers 110, and/or other potential buyers 112 may correspond to buyer(s) and/or potential buyer(s) of ticket(s) that one or more ticketholders 102 had purchased. The venue(s) 108 may include, by way of example without limitation, an institution, a business, a party, an organization, an entity, a location, a facility, a host, venue/event managers, and/or the like associated with an event. By way of example without limitation, an event may correspond to a live performance, another performance such as a recorded performance, a musical performance, an arts performance, a dance performance, a theatrical performance, an athletic event, a commercial event, a social event, a business event, a common interest event, an entertainment event, an educational event, a speaking/lecture event, and/or the like. A venue may benefit from potential buyer of tickets that ticketholders cannot use that particular venue's tickets in order to maximize the numbers of attendees at events.

The broker(s) 110 may include, by way of example without limitation, an individual, a business, an association, a party, an organization, a secondary market, an institution, and/or another entity involved in ticket transactions. The other potential buyer(s) 112 may include any other parties who may interface with the ticket information handling system 106. By way of example without limitation, the other potential buyer(s) 112 may include members of the general public, registered users of the ticket information handling system 106, distinct sets of users sharing a common attribute, other ticketholders that may be buyers of additional ticket(s), and/or the like. In some embodiments, an option to become a wholesale buyer may be presented via the ticket platform as an option to paying full price for tickets.

The data source(s) 114 may include any suitable source whereby information facilitating features of certain embodiment is accessible. By way of example without limitation, the data source(s) 114 may include internet-accessible databases, repositories, and/or web site/portals. The data sources 114 may provide information to the ticket information handling system 106 about ticket sales, secondary ticket markets, ticket offerings, market information, event information, sports teams, and the like, and/or may have access to records, databases, and/or other repositories containing such information.

In certain embodiments, one or more venue(s) 108, broker(s) 110, other potential buyer(s) 112, and/or data source(s) 114 could include one or more of a database, any repository of data in any suitable form, a website, and/or a server. In certain aspects, one or more venue(s) 108, broker(s) 110, and/or other potential buyer(s) 112 may be a user of the system; in certain aspects, one or more venue(s) 108, broker(s) 110, and/or other potential buyer(s) 112 may be a source of information about tickets. By way of example without limitation, one or more venue(s) 108, broker(s) 110, and/or other potential buyer(s) 112 may be a user that receives information whether through the network 104 or otherwise, may provide information to the ticket information handling system 106 about tickets, ticket interests, wants to buy, wants to sell, and/or the like, and/or may have access to records, databases, and/or other repositories containing information about tickets. Such information repositories may be electronically and accessibly linked to the ticket information handling system 106.

According to certain embodiments, the ticket information handling system 106 may be or include a ticket transaction platform. In various embodiments, one or more of ticketholder(s) 102, venue(s) 108, broker(s) 110, other potential buyer(s) 112, and/or data source(s) 114 may access and/or be accessed by the ticket information handling system 106 via interfaces 103, 109, 111, 113, 115, respectively. One or more of the interface(s) 103, 109, 111, 113, 115, may allow for transfer of and access to ticket information in accordance with certain embodiments disclosed herein. One or more of the interface(s) 103, 109, 111, 113, 115, may facilitate communication over the network 104 using any suitable transmission protocol and/or standard. Accordingly, the ticket information handling system 106 may have web site/portals giving access to such information. In some embodiments, one or more of the interface(s) 103, 109, 111, 113, 115, may include a web interface. One or more of the interface(s) 103, 109, 111, 113, 115, may cause a web page to be displayed on a browser.

In various embodiments, one or more of the interface(s) 103, 109, 111, 113, 115, may include any suitable input/output module or other system/device operable to serve as an interface to the platform. In various embodiments, the ticket information handling system 106 may include, facilitate, and/or provide one or more of the interface(s) 103, 109, 111, 113, 115, for example, by making available one or more of an API (application programming interface), a website, a web page, a web portal, a web application, a mobile application, enterprise software, and/or any suitable application software.

Thus, for example, one or more of the interface(s) 103, 109, 111, 113, 115, may include an API to facilitate communication with the ticket information handling system 106. And, one or more of the interface(s) 103, 109, 111, 113, 115 may or may not include a specialized interface of the corresponding party. For example, a broker interface may be a specialized interface. A broker may use proprietary or otherwise third party software for ticket transactions. An API may be available to a broker to allow communication between the broker software components and the ticket information handling system 106. In some embodiments, one or more of interfaces 103, 109, 111, 113, 115 may be customized and/or customizable for the respective party so that an interface it tailored to a particular party.

In certain embodiments, one or more of interfaces 103, 109, 111, 113, 115 may include or be configured for any computing device that may be suitable for sending and receiving information over a network in accordance with embodiments described herein. For example without limitation, in various embodiments, the computing device may include one or more devices variously referenced as a desktop computer, a computer terminal, a mobile phone, a cellular telephone, a smartphone, a handheld mobile device, a tablet computer, a web pad, a personal digital assistant (PDA), a notebook computer, a handheld computer, a laptop computer, or the like.

In various embodiments, one or more of interfaces 103, 109, 111, 113, 115 may include or be configured for providing one or more display screens that may each include one or more user interface elements. Interfaces may be customized for venues 108, brokers 110, other potential buyers 112, and/or data sources 114, and could be customized for particular one of said parties. One or more of interfaces 103, 109, 111, 113, 115 may include or be configured for providing a graphical user interface (GUI). A user interface may include any text, image, and/or device that can be displayed on a display screen for providing information to a user and/or for receiving user input. A user interface may include one or more widgets, text, text boxes, text fields, tables, grids, charts, hyperlinks, buttons, lists, combo boxes, checkboxes, radio buttons, and/or the like. In various embodiments, a dashboard may be presented, and the GUI may correspond to a page that a user might see after initialization of an app and/or logging on to the platform. The GUI may include any number and type of user-selectable options to facilitate various embodiments. In various embodiments, one or more user-selectable options may include one or more of a page flow, a screen-labeled function key, an icon, a button, a soft button, a window, a menu, a control widget, a scroll bar, a slider, a listbox, and/or the like. In various embodiments, one or more user-selectable options may be selectable via one or more of touch, push, movement-based selection, and/or any suitable navigation feature.

In certain embodiments, one or more of the interface(s) 103, 109, 111, 113, 115 may include a computing device. In certain embodiments, one or more of the interface(s) 103, 109, 111, 113, 115 may include a mobile computing device that may be any portable device suitable for sending and receiving information over a network in accordance with embodiments described herein. For example without limitation, in various embodiments, the mobile computing device may include one or more devices variously referenced as a mobile phone, a cellular telephone, a smartphone, a handheld mobile device, a tablet computer, a web pad, a personal digital assistant (PDA), a notebook computer, a handheld computer, a laptop computer, or the like.

In various embodiments, the data from the one or more data sources 114 may be retrieved and/or received by the ticket information handling system 106 via the network 104 and/or through any other suitable means of transferring data. For example, in some embodiments, the ticket information handling system 106 and the data sources 114 could use any suitable means for direct communication. According to certain embodiments, data may be actively gathered and/or pulled from one or more data sources 114, for example, by accessing a third party repository and/or by “crawling” various repositories.

FIG. 2 shows a high-level block diagram of a ticket information handling system 106-1, in accordance with certain embodiments of the present disclosure. The ticket information handling system 106-1 may correspond to the ticket information handling system 106 of FIG. 1, but one embodiment of the ticket information handling system 106 is shown in more detail. While engines, modules, repositories, and other components are described separately herein, it should be appreciated that the components may be combined and/or implemented differently in any combination to provide certain features in various embodiments. In various embodiments, different processes running on one or more shared computers may implement some of the components.

As depicted, the ticket information handling system 106 may include one or more processors 116 communicatively coupled to one or more memories 118. In certain embodiments, one or more processors 116 may correspond to one or more servers, which may include communication servers, web servers, gateways, application servers, database servers, and/or one or more other types of servers. In certain embodiments, the ticket information handling system 106 may be implemented in or with a distributed computing and/or cloud computing environment with a plurality of servers and cloud-implemented processing, memory, and data resources. Thus, with accretion of ticket information, the system may allow for scaling out with additional processing resources, server resources, data storage resources, data management resources, and the like. Some embodiments may use different types of servers to service different types of computing devices.

The ticket information handling system 106 may include one or more network interfaces 120 communicatively coupled to processors 116. The network interface(s) 120 may include any suitable input/output module or other system/device operable to serve as an interface between one or more components of the ticket information handling system 106 and the network 104. The ticket information handling system 106 may use the network interfaces 120 to communicate over the network 104 using any suitable transmission protocol and/or standard.

In some embodiments, one or more servers may communicate via one or more types of communication protocols, such as HyperText Transfer Protocol (HTTP), File Transfer Protocol (FTP), Wireless Application Protocol (WAP), etc. A server may provide static web pages, dynamic web pages, web services, web applications to a computing device of a ticket 106 for execution in a web browser running on the computing device, scripts for execution within an isolated environment in a browser, and/or rich-client applications to the computing device that may have access to functions of the operating system running on the computing device.

The ticket information handling system 106 may include one or more data repositories 128. One or more data repositories 128 may retain any ticket information suitable for embodiments of this disclosure. The data repositories 128 may include database(s), database management system(s), server(s) to facilitate management/provision/transfer of ticket information and other information related to embodiments of this disclosure. In various embodiments, the data repositories 128 may be implemented in various ways. For example, one or more relational or object-oriented databases, or flat files on one or more computers or networked storage devices, may store the information. It should be appreciated that information corresponding to the repositories may be stored elsewhere and/or in other ways, or may not be stored, depending on the implementations chosen. Likewise, while various segregations of information corresponding to the repositories are provided herein, it should be appreciated that such examples are non-limiting, and some or all the information may be handled in any suitable manner.

One or more authentication information repositories 130 may retain any authentication information suitable to facilitate security for embodiments of this disclosure. The authentication information repositories 130 may include database(s), database management system(s), server(s) to facilitate management/provision/transfer of authentication information, and/or the like. The repositories 130 may retain authentication information of one or more particular ticketholders 102, venues 108, brokers 110, and/or other potential buyers 112. The authentication information may include information to check credentials of ticketholders 102, venues 108, brokers 110, and/or other potential buyers 112 that may use one of their corresponding interfaces to seek access, transfer information, and/or make ticket transactions with ticket information handling system 106. The authentication information may be used to provide security for transactions, restrict the access granted to a certain set of information and/or features, implement certain control and/or features for certain parties, and/or the like.

One or more purchased ticket information repositories 132 may retain any information about purchased tickets that may be suitable to facilitate ticket buyback features for embodiments of this disclosure. The purchased ticket information repositories 132 may include database(s), database management system(s), server(s) to facilitate management/provision/transfer of purchased ticket information, and/or the like. The repositories 130 may retain purchased ticket information of one or more particular ticketholders 102, venues 108, brokers 110, and/or other potential buyers 112. The purchased ticket information may include information tracking purchased tickets that may be used for identifying tickets of interest, ticketholders of interest, and/or the like. For example, in response to a want-to-buy request or some other interest in repurchased tickets, the ticket information handling system 106 may search a purchased ticket information repository 132 for a potential match. Having found one or more potential matches, the ticket information handling system 106 may direct buyback options to the corresponding ticketholder(s). The buyback options may be targeted to a ticketholder and ticket(s). In some embodiments, the purchased ticket information repositories 132 may retain system repurchasing profile information could indicate predetermined pricing strategies, purchasing strategies, purchasing commitments, and/or the like for repurchasing ticket on behalf of the ticket information handling system 106.

One or more ticket identification information repositories 134 may retain any information about identification references that may be suitable to identify tickets for embodiments of this disclosure. The purchased ticket information repositories 134 may include database(s), database management system(s), server(s) to facilitate identification of purchased and repurchased tickets. The identification information may include identification references and mapping information for identifying and/or tracking tickets. The identification information may include a pool of unassigned references from which references may be selected for assignation. The identification information may include coding for tracking various items of information associated with a given ticket. An identification reference could be a unique identifier, and, in some embodiments, an identification reference may be a bar code associated with a tangible ticket and/or an electronic ticket.

In some embodiments, after a ticket has been repurchased, a different identification reference may be assigned to the repurchased ticket. The assignment of a different identification reference may allow the seller of original tickets to dispose or not dispose of the original tickets and/or ticket records without there being a risk of confusion or fraud based on the original tickets. The seller could dispose of original tickets, and another individual who may find the tickets would not be able to use them because the identification reference would no longer be valid.

One or more venue information repositories 136 may retain any suitable information related to venues. The venue information repositories 136 may include database(s), database management system(s), server(s) to facilitate interactions between one or more venues 108 and the ticket information handling system 106. The venue information may include without limitation venue identification information, organization details, payment methods, accounting information, credit information, asset information, collateral information, address information, contacts, user account information, venue repurchasing profile information, additional details, and the like. The venue repurchasing profile information could indicate arrangements for pricing strategies, purchasing strategies, purchasing commitments, and/or the like for interacting with the ticket information handling system 106.

One or more broker information repositories 138 may retain any suitable information related to brokers. The broker information repositories 138 may include database(s), database management system(s), server(s) to facilitate interactions between one or more brokers 110 and the ticket information handling system 106. The broker information may include without limitation broker identification information, organization details, payment methods, accounting information, credit information, asset information, collateral information, address information, contacts, user account information, broker repurchasing profile information, additional details, and the like. The broker repurchasing profile information could indicate arrangements for pricing strategies, purchasing strategies, purchasing commitments, and/or the like for interacting with the ticket information handling system 106.

One or more potential buyer information repositories 140 may retain any suitable information related to other potential buyers. The potential buyer information repositories 140 may include database(s), database management system(s), server(s) to facilitate interactions between one or more buyer 112 and the ticket information handling system 106. The potential buyer information may include without limitation buyer identification information, organization details, payment methods, accounting information, credit information, asset information, collateral information, address information, contacts, user account information, buyer repurchasing profile information, additional details, and the like. The other buyer repurchasing profile information could indicate arrangements for pricing strategies, purchasing strategies, purchasing commitments, and/or the like for interacting with the ticket information handling system 106.

One or more regulation information repositories 142 may retain any suitable information related to regulation of transactions with one or more ticketholders 102, venues 108, brokers 110, and/or other potential buyers 112. The regulation information may specify the business rules and/or procedures for controlling transactions. For example, in some embodiments, controls may be placed on certain tickets and/or purchasers to limit the quantity of tickets that may be purchased at one time and/or by certain purchasers. Certain brokers may be provided options to purchase relatively large quantities of tickets, or limitations may prevent purchase of relatively large quantities on certain brokers or other potential buyers. Any desirable limitation may be employed.

One or more repurchased ticket inventory repositories 144 may retain any information about repurchased tickets that may be suitable to facilitate ticket buyback features for embodiments of this disclosure. The repurchased ticket information repositories 144 may include database(s), database management system(s), server(s) to facilitate management/provision/transfer of repurchased ticket information, and/or the like. One or more ticket listings information repositories 146 may retain any information about tickets listed for sale via one or more sites via the platform, via one or more potential buyers, and/or via a secondary market.

Various embodiments of the ticket information handling system 106 may also include one or more engines 122 to implement any combination of features of embodiments described in the present disclosure. FIG. 3 is a block diagram illustrating certain aspects of the ticket information handling system 106-2 that may include one or more engines 122-1, in accordance with certain embodiments of the present disclosure. In various embodiments, the engines 122 may include one or more of interface handling engine(s) 122(a), account management engine(s) 122(b), ticket identification engine(s) 122(c), buyback workflow engine(s) 122(d), price analytics engine(s) 122(e), notification engine(s) 122(f), logging engine(s) 122(g), transaction handling engine(s) 122(h), information query engine(s) 122(i), and/or the like. While the engines 122(a)-(i) are shown separately, it should be appreciated that in various embodiments the one or more engines 122 may be implemented collectively and/or integrally. The engines 122 may be stored in memory 118 and may include one or more software applications, executable with the one or more processors 116, for receiving and processing data requests. The engines 122 may be configured to perform any of the steps of methods described in the present disclosure.

By way of example without limitation, in some embodiments, the interface handling engine(s) 122(a) may include logic to send, present, and receive information, with one or more of interfaces 103, 109, 111, 113, to/from one or more ticketholders 102, venues 108, brokers 110, other potential buyers 112, and/or data sources 114. The interface handling engine(s) 122(a), with one or more the processors 116, may utilize one or more network interfaces 120 to transceive information through the network 104. The ticket information handling system 106 may pull and/or push information from those entities in any suitable way.

In some embodiments, the account management engine(s) 122(b) may include logic for implementing account features in various embodiments. By way of example without limitation, the account management engine(s) 122(b) may include logic one or more aspects of: handling user registration; managing account creation, updates, authentication, handling; handling buyer deposit accounts; handling buyer credit accounts; and/or the like. The account management engine(s) 122(b) may be configured for acquiring, processing, formatting, and/or storing authentication information in the one or more authentication repositories 130.

In some embodiments, the ticket identification engine(s) 122(c) may include logic for implementing ticket identification features in various embodiments. By way of example without limitation, the ticket identification engine(s) 122(c) may include logic for one or more aspects of: handling ticket identification and verification; handling ticketholder identification and verification; assigning ticket identification references; invalidating obsolete identification references; creating, changing, and storing ticket information; creating, changing, and storing ticket identification information; and/or the like.

In some embodiments, the buyback workflow engine(s) 122(d) may include logic for implementing buyback workflow features in various embodiments. By way of example without limitation, the buyback workflow engine(s) 122(d) may include logic for one or more aspects of: creating, changing, and storing buyer profiles; presenting and handling buyback options; handling want-to-buy requests; and/or the like.

In some embodiments, the price analytics engine(s) 122(e) may include logic for implementing pricing features in various embodiments. By way of example without limitation, the price analytics engine(s) 122(e) may include logic for one or more aspects of: determining buyback prices; identifying and applying pricing controls/strategies implemented with buyer profiles and/or regulatory information; and/or the like.

In some embodiments, the notification engine(s) 122(f) may include logic for implementing notification features in various embodiments. By way of example without limitation, the notification engine(s) 122(f) may include logic for one or more aspects of: generating and sending notifications to platform users; receiving responses from platform users; coordinating responses and extracting pertinent information therefrom; alert sellers, potential sellers, buyers, and/or potential buyers regarding events of interest; and/or the like. The notification engine(s) 122(f) may be configured to check buyer notification profiles for handling notifications in accordance therewith.

In some embodiments, the logging engine(s) 122(g) may include logic for implementing information logging features in various embodiments. By way of example without limitation, the logging engine(s) 122(g) could process data pulled and/or pushed from various entities. The logging engine(s) 122(g) could handle process, extracting, formatting, and/or storing data may in one or more of the aforementioned repositories.

In some embodiments, the transaction handling engine(s) 122(h) may include logic for implementing ticket transaction features in various embodiments. By way of example without limitation, transaction handling engine(s) 122(h) include logic for handling purchase, sale, and transfer transactions. The transaction handling engine(s) 122(h) may apply regulation information specifying business rules and/or procedures for controlling transactions. The transaction handling engine(s) 122(h) may be configured for handling payment processing relating to transactions.

In some embodiments, the information query engine(s) 122(i) may include logic for implementing searching of one or more information repositories. Other engines 122 may include and/or utilize the information query engine 122(i) in various embodiments. The searching may be in response to information received over the network 104 from a user. Responsive to a query, the information query engine 122(i) may search, retrieve, modify, and/or cause transfer of particular information from one or more information repositories.

FIG. 4 illustrates a process 400 for facilitating an initial ticket purchase via a ticket platform, in accordance with certain embodiments of the present disclosure. Teachings of the present disclosure may be implemented in a variety of configurations that may correspond to the systems disclosed herein. As such, certain steps of the process 400, and the other methods disclosed herein, may be omitted, and the order of the steps may be shuffled in any suitable manner and may depend on the implementation chosen. Moreover, while the following steps of the process 400, and those of the other methods disclosed herein, may be separated for the sake of description, it should be understood that certain steps may be performed simultaneously or substantially simultaneously.

As indicated by block 405, a user may log into the ticket platform. First time users might have to set up an account, along with authentication information. Thus, the user may set up an account and register to provide credentials so that login may be authenticated according to authentication information stored in the authentication information repository 130. The user may intend to immediately purchase tickets via the platform. As indicated by block 410, an authentication information repository may be updated as necessary to reflect a new registration and/or new authentication information being provided.

As indicated by block 415, one or more tickets may be initially purchased by the user. As indicated by block 420, the one or more tickets may be provided with identification reference(s) assigned to the ticket(s). The identification reference(s) may be unique identifier(s). The tickets may in paper form, in other tangible form, and/or may correspond to an electronic record, which may be sent to the user and/or otherwise accessibly linked to the user. Thus, the user may become a ticketholder. In some embodiments, identification reference(s) may be assigned at a time of purchase; in other embodiments, identification reference(s) may be assigned prior to purchase.

As indicated by block 425, a purchased ticket information repository may be updated to reflect the purchase. As indicated by block 430, in some embodiments, a purchased ticket information repository may be updated as necessary to reflect a change in identification information due to the transaction.

FIG. 5 is a block diagram 500 that illustrates certain aspects of a wholesale ticket marketplace management lifecycle, in accordance with certain embodiments of the present disclosure. Diagram 500 may represent an overview of certain aspects of such a lifecycle, including overall flow(s) involved. Teachings of the present disclosure may be implemented in a variety of configurations that may correspond to the systems disclosed herein. As such, certain phases of the wholesale ticket marketplace management lifecycle illustrated in the diagram 500 may be omitted, and the order of the phases may be shuffled in any suitable manner and may depend on the implementation chosen. Moreover, while the following phases of the wholesale ticket marketplace management lifecycle may be separated for the sake of description, it should be understood that certain steps may be performed simultaneously or substantially simultaneously.

As indicated by block 505, one phase of the life cycle may correspond to a potential buyer registration and account creation stage. According to various embodiments, a buyer or potential buyer may correspond to one or more of a venue, a broker, the ticket buyback system or a component or associate thereof, a fan or other end user, and/or any other suitable type of buyer or potential buyer that may buy or be interested in buying one or more previously sold tickets. A buyer or potential buyer may purchase one or more tickets for resale. In some embodiments, one or more automated process flows may facilitate the provisioning of buyers with accounts and security access. Buyer accounts may be created in various ways in various embodiments, and may be initiated by a buyer in some cases.

As indicated by block 510, one phase of the life cycle may correspond to a potential buyer profile stage. In various embodiments, a profile may be created, retrieved, and/or updated. For example, a buyer profile could be created along with the registration of buyer. As another example, an existing buyer with whom business has already been transacted may already be the system, and may already have a profile that may be retrieval and/or updated.

The buyer profile may include a purchase commitment profile. Once a potential buyer has an account and is logged in, a potential buyer may set up automated parameters. The potential buyer could agree to purchase tickets according to various parameters that may be defined a purchase commitment profile for the potential buyer. In some embodiments, a purchase commitment profile may allow the system to automatically determine buyback prices, given particular tickets under consideration. A commitment profile may be negotiated in some cases.

In some embodiments, a transaction may be processed automatically on behalf of a buyer according to a purchase commitment profile. Accordingly, some embodiments could provide virtual buyer services. The buyer could have previously agreed to certain buying parameters, which may be specified in a purchase commitment profile. Automated parameters could concern quantities of tickets. For example, a buyer, such as a broker, may have committed to buy a certain number of tickets. A buyer may have committed to buy according to set of one or more prices. A buyer may have committed to buy certain types of tickets, tickets for certain events, tickets for one or more certain venues, tickets corresponding to one or more certain categories, and/or the like.

Automated parameters could concern timing. A buyer may place a time limit to create a purchasing window. The purchasing window could encompass any suitable time period before an event, and may extend until a certain time before the event, say until a number of days before the event to allow the buyer time to resell the tickets. A purchase commitment profile may include any suitable buying parameters, including any suitable restriction and/or limit, that a buyer has previously agreed to for automatic processing of a buyback transaction. A purchase commitment profile could have manifold conditions defining pricing strategies. Pricing strategies could include various stages, such as a gradated pricing scale that decreases as the time till the event decreases. Pricing strategies could include various differentiators of seats, event times, event days, events, and/or the like. Any suitable pricing strategies may be employed, including, without limitation, defining price thresholds, prices dependent on discounts based on face values of tickets, prices dependent on discounts based on current market values of tickets, time frame thresholds, prices dependent on time left before an event, prices dependent on market information, prices dependent on event and/or venue, prices dependent on risk that tickets cannot be resold, prices dependent on intended redirection of the tickets such as for charity, and/or the like.

In some embodiments, certain price constraints may be specified for certain buyers, such as brokers. The price constraints may be specified for certain events. For example, a constraint may be imposed on brokers to maintain certain prices for certain events so that, if a ticket becomes available, a broker would have to accept it. Certain limits may be specified for price constraints. For example, a price constraint may be imposed on a broker up a limit of ten tickets, and, after a broker has met the commitment of accepting ten tickets at a specified price(s), the broker may have additional options. For example, the broker could have an option for a delayed response time, which would allow the broker a time window to look more closely at the pricing.

In some embodiments, the buyer profile may include a notification profile. The notification profile may specify parameters for notifying the buyer, and could also specify parameters for buyer responses to notifications from the system such as requests for bids. In some embodiments, one or more potential buyers may receive a notification from the system. In some embodiments, a notification may specify one or more prices at which the potential buyer may buy the one or more tickets. A notification could invite the buyer to accept certain tickets at a certain price. In some embodiments, a broker could have an option to counteroffer with a different price. In some embodiments, notification could include an option to buy one or more tickets, or a notice that one or more tickets have been or are to be purchased on the buyer's behalf. In some embodiments, the notification could seek a bid from the buyer for certain tickets.

In some embodiments, the platform may send a notification to a buyer, which notification, for example, could be provided via a buyer dashboard provided via the platform. However, any suitable means of notification may be employed. For example, text, voice, e-mail, alerts with the application, and/or the like could be sent. The notification could include a link or other communication reference referring back to the platform, prompting the buyer to respond. For example, the notification could provide a link for users to log into the platform to respond.

As indicated by block 515, in some embodiments, one phase of the life cycle may be directed to presenting buyback options to a ticketholder(s). A buyback option may be presented via the ticket platform. The buyback option may be a user-selectable option presented via a ticketholder interface.

As indicated by block 520, in some embodiments, one phase of the life cycle may be directed to determining a buyback price(s) for one or more tickets considered for buyback. In some embodiments, the system may present a predetermined ticket price. In some embodiments, the system may determine and present a ticket price. The ticket price could be based at least in part on the face value of the ticket or current market value of the ticket. The ticket price could be based at least in part on time remaining before the event. A ticket may be priced at a discount to reflect built-in price protection for an assumption of risk associated with selling. In some cases, a ticketholder may not be able to attend an event, and the tickets could be viewed as corresponding to surplus inventory that may be almost thrown away. Rather than take a total loss on the tickets, a ticketholder may decide to quickly sell a ticket at a price on the order of half the face value of the ticket or less. Also, if a ticket seller is asking for a certain price for a certain ticket, oftentimes there is no way to reliably discern what a potential buyer would be willing to pay for the ticket at a certain time. And avoiding the hassle of shepherding tickets through an advertising process may be additionally reason for the ticketholder to decide to quickly sell a ticket at a discount price.

In some embodiments, the system may access market information, which may include sales information, and determine a ticket price based at least in part on the market information. The sales information could include sell rates. A ticket price may be identified based at least in part on demand in the marketplace. In some embodiments, a ticket price may be adjusted automatically based at least in part on demand in the marketplace.

In some embodiments, the system may determine a market trend in some embodiments, and a ticket price based at least in part on the market trend. In some embodiments, determining a market trend may involves assessing past and current market data, and extrapolating data out to predict future market data. A market trend could be based on factors external to the sales information. For example, if a sports team is doing well, prices can be raised at the box office; if the team takes a downturn, prices can be lowered. Prices could be automatically adjusted based on wins and losses. The price changes as a function of wins and losses could be linear or non-linear. As another example, price adjustment could be similarly tied to team rankings with respect to other teams. As another example, price adjustment could be additionally based on performance and/or rankings of opponent teams. Even though prices may be adjusted upward based on the home team's past wins, losses, and/or rankings, prices may adjusted downward when the home team plays the worst team in the league. Various factors used could be assigned one or more weights. So, for example, home team performance may be assigned a greater weight than opponent team performance such that, in the case of a successful home team playing against an unsuccessful opponent, downward price adjustments due to the opponent may be less than the upward price adjustments due to the home team.

According to certain embodiments, market information may be actively gathered and/or pulled from any one or combination of one or more venue(s) 108, broker(s) 110, other potential buyer(s) 112, and/or data source(s) 114—for non-limiting example, by accessing a repository that corresponds to those entities. Data could be gathered by “crawling” various repositories in some embodiments. In addition or in the alternative, data may be pushed from any one or combination of one or more venue(s) 108, broker(s) 110, other potential buyer(s) 112, and/or data source(s) 114 to the ticket information handling system 106. Updates for repositories may be periodically found. With some embodiments, any one or combination of one or more venue(s) 108, broker(s) 110, other potential buyer(s) 112, and/or data source(s) 114 may provide notice to the ticket information handling system 106 of data to be transferred, such as updated information not previously pulled/pushed to the ticket information handling system 106. With some embodiments, data may be updated at the ticket information handling system 106 after a user logs into/initiates an interface of the platform, e.g., a website, a web page, a web portal, a web application, a mobile application, enterprise software, and/or any suitable application software.

As indicated by block 525, in some embodiments, one phase of the life cycle may be directed to the system purchasing tickets from ticketholder(s) according to a buyer's purchase profile. Responsive to a ticketholder selection, the system may process the buyback of tickets based at least in part on buying parameters specified in the buyer's purchase commitment profile. As discussed herein, in various embodiments, a buyer's purchase commitment profile may be directed to any of various suitable parameters for purchasing tickets on behalf of the buyer. A purchase may entail entry of an identification reference, such as a barcode. Completion of the transaction may be based at least in part on reception of the identification code and funding information.

As indicated by block 530, in some embodiments, one phase of the life cycle may be directed to charging the buyer based on transaction processed and/or services provided by the system. In some embodiments, a buyer could be charged based on the buyer's transactions. Charges could be based on a flat rate, a percentage of a transaction amount, and/or any other suitable transaction-based criterion. In some embodiments, a broker and/or other buyer of the platform could be charged to use the platform and/or receive discounted prices on the platform. An amounted charged could be at least partially based on a percentage of a discounted price in some embodiments. Thus, in some embodiments, a buyer could be charged one or more fees for use of the platform. One or more fees could be based on transaction type, volume, buyer performance, and/or any other suitable service-based criterion.

In some embodiments, a buyer may be pre-screened in view of extending buying credit for use with ticket buyback. For example, a small-scale buyer may be extended five thousand dollars of buying credit. The buying credit could limit the number of tickets that the buyer is able to purchase through the system before payment is required. Any of various suitable amounts of credit may be extended to various buyers. The amount of buying credit extended may be depend on the size of the buying organization, past history of buyer's interactions with the platform, credit history, assets, collateral, sales volume, and/or the like.

Certain embodiments may provide features that facilitate urgent action because of actions occurring with a short time window, such a five-minute window. Once a buyer reaches the buyer's credit limit, the platform may notify the buyer. In some cases, the notification could prompt to pay down the balance on the buyer's account to any suitable extent. A time limit could be imposed for the buyer pay down the account. For example, the buyer could be notified that account payment is required in the next five minutes in order to avoid disablement of buying services. In some embodiments, the platform may send a notification to a buyer, which notification, for example, could be provided via a buyer dashboard provided via the platform. However, any suitable means of notification may be employed. The notification could include a link or other communication reference referring back to the platform, prompting the buyer to respond. For example, the notification could provide a link for the buyer to log into the platform to respond and make a payment.

In some embodiments, in addition or in the alternative to a credit account, deposit account features may be provided. For example, those buyers that do not qualify for credit may use a deposit account. And, once a buyer depletes the buyer's deposit account, the platform may notify the buyer that funding is required. In such cases, buying services could be disabled until funding is received.

With the buyer's notification profile, the buyer could set up any a various notification preferences with respect to the buyer's account. For example, a buyer could specify that any one or combination of various alerts be sent to the buyer as certain thresholds are reached on the buyer's account. A buyer could also specify that certain transactions require preauthorization by the buyer. For example, prior to completion of a transaction over a certain amount, a notification could be sent to the buyer, requesting preauthorization.

In some embodiments, payment may be transferred to/from a buyer's bank account after completion of one or more transactions. In some embodiments, a buyer's account may be credited/debited after completion of one or more transactions. In some embodiments, prior to completion of a transaction, the buyer's account(s) may be checked to ensure that sufficient funds and/or credit are available to support the transaction. In some embodiments, prior to completion of a transaction, a buyer may be notified of the prospective transaction, and confirmation of sufficient funds and/or credit may be requested.

As indicated by block 535, in some embodiments, one phase of the life cycle may be directed to the system seeking a buyback price from one or more potential buyers. Automatically or responsive to user selection, the system may seek the best buyback price for a user from one or more potential buyers. The system could send one or more notifications to potential buyers, seeking offers to buy the user's tickets. The notifications could be sent according to various parameters that may be defined in a notification profile for a given potential buyer. A buyback price could be determined based on one or more responses from potential buyers.

A time period could be specified for seeking a buyback price. The system could initially identify the time period with the option presented via the user interface in some embodiments. In some embodiments, the system could identify the time period responsive to user selection of the option. Any desirable time period could be specified, five minutes, fifteen minutes, an hour, a day, etc.

In some embodiments, a make-me-an-offer option could be presented for selection by the ticketholder. The ticketholder could set a make-me-an-offer price, which could be conveyed to one or more potential buyers via notifications and/or listings features. Once an offer is received, the offer could be presented to the ticketholder so that the ticketholder may accept or decline the offer.

In some embodiments, multiple buyback options could be presented, simultaneously or otherwise. For example, an instant buyback price could be presented to the user as indicated by block 520, with an option to seek a better buyback price as indicated by block 535, in which case, a time period could be specified for seeking a buyback price. Multiple time period options could be presented to the user for selection. A user, for example, may select an option to seek the best buyback price determined in five minutes, as well as the best buyback price determined in eight hours. In that way, if a best buyback price determined in five minutes is better than the instant buyback price and satisfactory to the user, the user may wish to sell at that price, rather than wait eight hours to see if an even better is offered. Alternatively, the user may be willing to wait the eight hours to see if an even better is offered.

In some embodiments, responsive to user selection of an option to seek a best buyback price, the system could send one or more notifications to potential buyers. A time period for potential buyer response could be indicated. In some embodiments, a time limit for potential buyer response could be imposed. In some embodiments, certain potential buyer(s) could have agreed to response with a certain time period.

In some embodiments, notifications to potential buyers could be broadcasted to a set of potential buyers. The first potential buyer to respond with a price could be selected such that the price is presented to the user. Alternatively, the system could assess potential buyer responses at or near the end of the time period for response and select the best price for presentation to the user.

In some embodiments, a notification could be sent to one potential buyer at a time. The particular potential buyer could respond with a price and that price could be presented to a user. Potential buyer(s) could be selected from a pool of potential buyers according to any suitable basis. For example, a round robin scheme could be employed to select a potential buyer from the pool. As another example, selection of potential buyers could be based on commitment profiles, where a certain number or percentage of referrals is to be routed to certain potential buyers. The commitment profiles could include preference points where certain potential buyers with enhanced packages are granted preference points over other potential buyers with other profiles.

As indicated by block 540, in some embodiments, one phase of the life cycle may be directed to the system purchasing tickets from ticketholder(s) according to the best buyback price determining form responses of one or more potential buyers. Responsive to a ticketholder selection, the system may process the buyback of tickets according to the best buyback price. In some embodiments, the transaction may be based at least in part on buying parameters specified in the buyer's purchase commitment profile. In some embodiments, following the purchase phase may be the phase of the life cycle directed to charging the buyer based on transaction processed and/or services provided by the system, as indicated by block 530.

As indicated by block 545, in some embodiments, one phase of the life cycle may be directed to a want-to-buy feature. A want-to-buy option may be presented via the ticket platform. The want-to-buy option may include one or more user-selectable options presented via a broker interface or other interface, for example. A broker, venue, and/or other party may indicate a want to buy tickets. Any of various parameters may be specified for the tickets of interest. Desired tickets could be specified by any one or combination of a particular event, event dates, categories of events, ticket prices, ticket categories, and/or the like. For example, a potential buyer could specify an interest in a certain number of tickets for a certain event in a certain location within a certain time window at a certain price or price range. A potential buyer could specify intent to buy several different section/row combinations at various prices. In some embodiments, such intentions could published to ticketholders via a buyback option and/or responsive to selection of a buyback option. The want-to-buy could also specification a time limit so that the request is to expire after a certain time. For example, a potential buyer could specify that the want-to-buy request expires after one hour after issuance.

As indicated by block 550, in some embodiments, one phase of the life cycle may be directed to checking a repurchased ticket inventory, if any, for the desired tickets. In some embodiments, the system may maintain an inventory of repurchased tickets from previous buyback transactions. In some embodiments, one or more other parties using the platform may maintain an inventory of repurchased tickets from previous buyback transactions. The system could maintain records of a party's repurchased ticket inventory and/or poll the party for the desired tickets responsive to the want-to-buy request. In the event that the desired tickets are identified within a repurchased ticket inventory, the next phase may be as indicated by block 555.

As indicated by block 555, in some embodiments, one phase of the life cycle may be directed to purchasing tickets from another party(ies) according to the want-to-buy request, or, if the desired tickets were found in the system's repurchased ticket inventory, sell the tickets according to the want-to-buy request. The system may process the transaction automatically, or may notify the requesting buyer and process the transaction responsive to confirmation by the requesting buyer. In some embodiments, the transaction may be based at least in part on buying parameters specified in the buyer's purchase commitment profile. When a buyer buys one or more tickets from the ticket information handling system 106, the ticket information handling system 106 may automatically delist the ticket so that it is no longer offered for sale. In certain cases, the ticket information handling system 106 may be configured to send a notification to other parties, such as brokers, informing of them of the purchase. Accordingly, if other parties are involved in offering the tickets for sale, they make likewise delist the tickets. In some embodiments, following the purchase/sell phase, or along therewith, may be the phase of the life cycle directed to charging the buyer based on transaction processed and/or services provided by the system, as indicated by block 530.

As indicated by block 560, in some embodiments, one phase of the life cycle may be directed to presenting one or more targeted buyback options. In some embodiments, one or more ticketholders may be identified as potential sellers and may receive a notification about an opportunity for ticket sale. For example, in response to a want-to-buy request or some other interest in repurchased tickets, the system may search a purchased ticket information repository in view of the specified ticket parameters for a potential match. The notification also could be targeted to a potential sellers based on other known information about the sellers, such as ticket user history, one or more past purchases, user account preferences, and/or the like. Having found one or more potential matches, the system may direct buyback options to the corresponding ticketholder(s).

In some embodiments, the notification may specify one or more prices at which the potential seller may sell the one or more tickets. The notification could include an option to sell one or more tickets that may be presented in any suitable manner. Certain embodiments could include one or more of electronic notifications, telephonic notifications, texting notifications, push notifications, etc. to the potential seller, and/or alert notifications posted to the potential seller's account with the ticket platform. Thus, for example, a mobile app, SMS text, or a web page may be used to alert ticketholders regarding buyback options. For example, notifications may be provided to a ticketholder that after initialization of an app or after logging on to the platform according to various embodiments. For example, a window could pop up on the user interface indicating that potential buyers are standing by and interested in tickets at a particular price if the ticketholder wants to sell his ticket(s). Accordingly, the buyback options may be targeted to one or more ticketholders and tickets.

As indicated by block 565, in some embodiments, one phase of the life cycle may be directed to the system purchasing tickets from ticketholder(s) according to the want-to-buy request. The system may process the transaction automatically, or may notify the requesting buyer and process the transaction responsive to confirmation by the requesting buyer. In some embodiments, the transaction may be based at least in part on buying parameters specified in the buyer's purchase commitment profile. In some embodiments, following the purchase phase may be the phase of the life cycle directed to charging the buyer based on transaction processed and/or services provided by the system, as indicated by block 530.

FIG. 6 illustrates a process 600 for facilitating ticket buyback via a ticket platform, in accordance with certain embodiments of the present disclosure. As indicated by block 602, a user may log into the ticket platform. The user may correspond to a ticketholder. In some cases, the user could be new to system, in which case, the user may set up an account and register to provide credentials so that login may be authenticated according to authentication information stored in the authentication information repository 130. In other cases, the user could have previously set up an account, in which case the user's credentials provided with login may be authenticated according to authentication information previously stored in the authentication information repository 130. Responsive to a login attempt, the authentication information repository 130, which could correspond to one or more servers, dedicated or shared, in some embodiments, may for example facilitate access to the ticket platform.

As indicated by block 604, a buyback option may be presented via the ticket platform. The buyback option may be a default option or an option targeted to the ticketholder. The buyback option could be presented responsive to a want-to-buy request, from a broker, a venue, another fan, or another potential buyer. As indicated by block 606, in some embodiments, the system may present a price for ticket buyback. The price could be determined by one or more of the system, a buyer profile, a want-to-buy request, etc., which is discussed further herein. In some embodiments, the platform may also present to the ticketholder what other fans are getting for similar tickets within the marketplace. For example, the platform may offer a ticket listing feature where fans may post tickets for sale. Data from sales of such listing could be gathered, analyzed, and certain aspects of such could be indicated to the ticketholder. Hence, the ticketholder could be apprised of certain aspects such average/median/maximum/minimum prices similar tickets are being sold for, price trends of similar tickets are being sold for as respective event dates near, ranges of prices similar tickets are being sold for, etc. In some embodiments, the system could also capture external market information, as discussed herein, and likewise present similar information to the ticketholder.

As indicated by block 608, a selection of the buyback option may be received from the user. As indicated by block 610, in some embodiments where the system has not already identified ticket(s) for buyback per block 606, an identification of ticket(s) for buyback may be received from the ticketholder user. The input may correspond to the tickets that the ticketholder wants to resell.

As indicated by block 610, in some embodiments where the system has not already identified ticket(s) for buyback as indicated by block 606, the system may identify ticket(s) for buyback. For example, the ticketholder could have previously purchased through the ticket platform only certain tickets for a certain event that has not yet occurred. By virtue of those being the only pending tickets of the ticketholders recorded in the system, the ticket platform may identify and present those tickets by default. In cases where multiple event options exists for pending tickets of the ticketholder, the ticket platform may identify and present those tickets for selection by the ticketholder.

As indicated by block 612, in some embodiments where the system has not already presented a price for ticket buyback as indicated by block 606, the system may identify and/or present a price for ticket buyback. The system may determine or have predetermined a price in any suitable manner, including the various approaches discussed herein, such as determining a price based at least in part on face value, demand, market information, a want-to-buy request, etc. In some embodiments, the system may determine or have predetermined a price based at least in part on one or more purchase commitment profiles predetermined with one or more potential buyers. A potential buyer could have previously agreed to purchase tickets according to various parameters that may be defined a purchase commitment profile for the potential buyer. Having determined a buyback price based at least in part on one or more purchase commitment profiles, the system may present the buyback price to the user.

In some embodiments, the system may determine a price based on sending one or more notifications to potential buyers, seeking offers to buy the user's tickets, and determining a price based on one or more responses from potential buyers. A potential buyer could have previously agreed to receive notifications. The notifications could be sent according to various parameters that may be defined a notification profile for a given potential buyer.

As indicated by block 614, identification reference(s) for the ticket(s) presented for buyback may be received from the user. An identification reference could be a unique identifier, and, in some embodiments, an identification reference may be a bar code associated with a tangible ticket and/or an electronic ticket. In some embodiments, an identification reference may include a character string that could be keyed in by the user. In some embodiments, the ticket(s) may be identified by way of scanning, capturing an image, and the like. For example, a ticketholder could capture a ticket barcode or other identifier by scanning or taking a photo (e.g., with a camera of the ticketholder's computing device), and an uploading the corresponding data to the system.

As indicated by block 616, the identification reference(s) may be verified. For example, the identification reference(s) may be validated against information stored by the system. In various embodiments, information stored in one or more of authentication information repositories 130, purchased ticket information repositories 132, and/or ticket identification information repositories 134 may be used to verify the identification reference(s). As indicated by block 618, it may be determined whether any problems arise with the verification. In the case that a problem does arise, flow may transition to block 620. As indicated by block 620, an error message may be generated, and any suitable logging may be performed such that follow-up action may be taken by personnel associated with the system, as appropriate. However, in the case that a problem does not arise, flow may transition to block 622.

As indicated by block 622, a final confirmation and acceptance of the buyback offer may be received from the user. As indicated by block 624, payment and/or credit may be provided. In some embodiments, the user may be provided with a user account credit. In some embodiments, the user may provide routing information so that payment may be routed/sent to a bank account or to a postal address. Any suitable method of payment processing may be used.

As indicated by block 626, the identification reference(s) associated with the original ticket(s) may be invalidated. This may allow the ticketholder to either dispose or not dispose of the original tickets and/or ticket records without there being a risk of confusion or fraud based on the original tickets. Even if another individual may find disposed of tickets, the tickets would be unusable because the identification references would no longer be valid. As indicated by block 628, different identification reference(s) may be assigned to the repurchased ticket(s). The different identification reference(s) may be selected a pool of unassigned references. As indicated by block 630, an update regarding the ticket identification may be stored. For example, a purchased ticket information repository may be updated to reflect a change in identification information due to the transaction. As indicated by block 632, an update regarding the repurchased may be stored. For example, a ticket information repository may be updated to reflect the transaction.

As indicated by block 634, in some embodiments, one or more notifications may be sent regarding the update of ticket identification reference(s). For example, in some embodiments, after an original ticket has been repurchased, the ticket information handling system 106 may be configured to send a notification to the seller, informing that the identification reference of the original ticket is no longer valid and that the original ticket can longer be used at the corresponding venue. The notification could be presented by way of a message displayed with a page the platform. As another example, in some embodiments, the ticket information handling system 106 could be configured to send a notification to the corresponding venue, informing that the original ticket is no longer valid, that identification reference of the original ticket is no longer valid, and/or that the original ticket has been repurchased.

FIG. 7 illustrates a process 700 for facilitating a request for tickets via ticket buyback with the ticket platform, in accordance with certain embodiments of the present disclosure. As indicated by block 702, a request with an indication of interest in one or more tickets may be received by system. For example, the request may correspond to a want-to-buy from a broker or another potential buyer. Another potential buyer could be another fan, for example. As indicated by block 704, one or more ticket parameters may be identified and processed based on the request.

As indicated by block 706, it may be determined whether a corresponding item exists in the system's repurchased ticket inventory, if any. The repurchased ticket inventory may be searched based on the one or more ticket parameters. In the case of a determination that a corresponding item does exist in the system's repurchased ticket inventory, flow may transition to block 716. However, in the case of a determination that a corresponding item does not exist in the system's repurchased ticket inventory, flow may transition to block 708.

As indicated by block 708, it may be determined whether a corresponding item exists in the system's purchased ticket inventory. In the case of a determination that a corresponding item does not exist in the system's purchased ticket information repository, flow may transition to block 710. As indicated by block 710, the requester may be notified regarding the search results. Optionally, the system may identify and offer alternative suggestions based on the one or more ticket parameters. For example, the system may process one or more subsets of parameters and identify corresponding items in the repurchased ticket inventor and/or purchased ticket inventory. Such corresponding items could be offered as suggestions. As another example, the system may characterize tickets based at least in part on the one or more parameters, identify similar tickets based at least in part on the characterization, and offer the similar as suggestions. However, in the case of a determination that a corresponding item does exist in the system's purchased ticket information repository, flow may transition to block 712. As indicated by block 712, one or more corresponding ticketholders may be identified, for example, based at least in part on stored potential buyer information. As indicated by block 713, the request may also be saved for future potential corresponding ticketholders that may be later identified. Following ticketholder identification, flow may transition to any suitable point in the process 600 so that one or more targeted buyback options may be presented to the one or more corresponding ticketholders.

As indicated by block 716, in the case of a determination that a corresponding item does exist in the system's repurchased ticket inventory, a ticket transaction may be completed according to purchase commitment profile and/or the request. As indicated by block 718, in the case that the ticket platform had listed the tickets for sale, the tickets may be delisted due to the ticket transaction. In some embodiments, one or more tickets may get shipped to a buyer. In some embodiments, one or more tickets may be available to a buyer for download. In some embodiments, an inventory may be updated to reflect assignment of one or more tickets to a buyer. In some embodiments, one or more tickets may be assigned to a buyer's inventory.

As indicated by block 720, in the case that one or more other sellers had been offering, or were to be offering, the tickets for sale, the one or more other sellers may be notified of the sale so that the same tickets are not offered for sale. A broker, for example, may syndicate out tickets to any of a variety of different sites for ticket transactions. Thus, the system may automatically send the broker a notification per the broker's notification profile in some embodiments, which may indicate one or more preferred methods of contact. Similarly, when a broker sells one or more tickets, the broker may send a notification to the system. Responsive to the notification, the system may be configured to delist the ticket, automatically or after internal review, so that it is no longer offered for sale. As indicated by block 722, a repurchased ticket inventory may be updated to reflect the transaction. As indicated by block 724, a purchased ticket information repository may be updated to reflect the transaction.

FIG. 8 illustrates another process 800 for facilitating ticket buyback via a ticket platform, in accordance with certain embodiments of the present disclosure. As indicated by block 802, a user may log into the ticket platform. The user may correspond to a ticketholder. As indicated by block 804, in some embodiments, the platform may provide a feature that allows a ticketholder to offer one or more tickets for sale. For example, tickets could be listed for sale via a website provided by the system. As indicated by block 806, a selection of the listing option may be received from the user. As indicated by block 808, identification reference(s) for the ticket(s) that the user intends to list may be received from the user. As indicated by block 810, the identification reference(s) may be verified. As indicated by block 812, it may be determined whether any problems arise with the verification. In the case that a problem does arise, flow may transition to block 814. As indicated by block 814, an error message may be generated, and any suitable logging may be performed such that follow-up action may be taken by personnel associated with the system, as appropriate. However, in the case that a problem does not arise, flow may transition to block 816.

As indicated by block 816, it may be determined whether the ticket(s) correspond to any pending request. For example, as illustrated in process 700, previously received want-to-buy requests may have been saved for future potential corresponding ticketholders that may be later identified. In the case that the ticket(s) correspond to a pending request, a buyback option may be presented via the platform, as indicated by block 818. The flow may then transition to block 622 of process 600 in some embodiments.

However, in the case that the ticket(s) do not correspond to a pending request, flow may transition to block 820. As indicated by block 820, in some embodiments, a listing price may be received from the user for the ticket(s). As indicated by block 822, in some embodiments, one or more potential buyers may be notified about the offer of the ticket(s) for sale. In some embodiments, such notification may occur in real time after the ticketholder identify the ticket(s) for listing. As indicated by block 824, in some embodiments, the system may list the ticket(s) for sale via a website provided by the system. As indicated by block 826, an indication of interest and/or a counteroffer may be received from one or more potential buyer. A potential buyer could indicate, for example, that the listing offer is acceptable. Or, a potential buyer could counteroffer with a different buyback price. In some embodiments, one or more potential buyer responses could be received before the ticket(s) are listed for sale, responsive to the notification(s). In some embodiments, one or more potential buyer responses could be received after the ticket(s) are listed for sale, responsive to the notification(s) and/or the listing. As indicated by block 828, a buyback option may be presented to the user via the platform, presenting the indication of interest and/or counteroffer. The flow may then transition to block 622 of process 600 in some embodiments.

In some embodiments, notifications to potential buyers may include placing advertisements. For example, an advertisement may be placed, automatically or otherwise, on a website of a potential buyer and/or secondary market having a relationship with the system. A broker, for example, allow advertisement placement on the broker's website. The advertisement could take any suitable form, including banner advertisements, inclusion a broker's listing of offers for sale, and the like. The advertisement may include a link or other communication reference referring back to the platform. Accordingly, certain embodiments may provide an automated advertisement service.

FIG. 9 is a diagram 900 that illustrates certain aspects of a notification hierarchy, in accordance with certain embodiments of the present disclosure. Certain embodiments may implement a first option hierarchy for venues 108. Venues 108 could be afforded a first pass to satisfy a ticketholder in his desire to sell his ticket. Not only could a first hierarchy option serve the ticketholder's need, it may well benefit the venue 108 to maximize attendance at its events.

With a purchase commitment profile, a venue 108 could specify various conditions tailored to the venue's interests. For example, a venue 108 could specify one or more price thresholds at which the venue 108 will automatically buy tickets back. The venue 108 could (as other potential buyers could) specify a range of prices, certain prices, and/or a fraction of face value ticket prices. As one instance, a venue 108 may indicate that for one fifth of face value, the venue 108 will buy any ticket back. For more popular events, the venue 108 could indicate higher price thresholds. Even if an even was not selling out, buyback could allow a venue to resell the tickets as group tickets, as promotional tickets, and/or at a mark-up above the buyback price. The mark-up could be modest in some cases, as one prime interest may in filling seats. The first hierarchy option could allow a venue 108 to direct the repurchased tickets to charitable organizations.

If the venue 108 declines the buyback option or fails to respond within a particular time frame, the option may pass to brokers 110 in some embodiments. Notifications could be broadcasted many or all brokers 110 associated with the platform in some embodiments. Alternatively, notifications could be sent in seriatim to certain brokers 110 associated with the platform in some embodiments. In some embodiments, one or more notifications could be sent to first subset of one or more brokers 110-1. The first subset of brokers 110-1 could be selected from a pool of brokers according to any suitable basis. For example, a round robin scheme could be employed to select the one or more brokers 110-1. As another example, selection of brokers 110-1 could be based on commitment profiles and/or other user agreements, where a certain number or percentage of referrals is to be routed to certain brokers 110-1. Certain brokers 110-1 could have agreed to user packages that are granted preferences over other packages. An enhanced package, for instance, could come with a commitment that a given broker 110-1 would receive a certain percentage of notifications, which may be capped at a certain number for a given time period. After reaching the cap, the given broker 110-1 could receive notifications on another basis.

If the first subset of brokers 110-1 declines the buyback option or fails to respond within a particular time frame, the option may pass to additional subset(s) of brokers 110-n or all other brokers 110-n in some embodiments. If the additional broker(s) 110-n declines the buyback option or fails to respond within a particular time frame, the option may pass to other potential buyer(s) 112-1, which could include any other users of the system and/or secondary markets.

Referring next to FIG. 10, an exemplary environment with which embodiments may be implemented is shown with a computer system 1000 that can be used by a designer 1004 to design, for example, electronic designs. The computer system 1000 can include a computer 1002, keyboard 1022, a network router 1012, a printer 1008, and a monitor 1006. The monitor 1006, processor 1002 and keyboard 1022 are part of a computer system 1026, which can be a laptop computer, desktop computer, handheld computer, mainframe computer, etc. The monitor 1006 can be a CRT, flat screen, etc.

A designer 1004 can input commands into the computer 1002 using various input devices, such as a mouse, keyboard 1022, track ball, touch screen, etc. If the computer system 1000 comprises a mainframe, a designer 1004 can access the computer 1002 using, for example, a terminal or terminal interface. Additionally, the computer system 1026 may be connected to a printer 1008 and a server 1010 using a network router 1012, which may connect to the Internet 1018 or a WAN.

The server 1010 may, for example, be used to store additional software programs and data. In one embodiment, software implementing the systems and methods described herein can be stored on a storage medium in the server 1010. Thus, the software can be run from the storage medium in the server 1010. In another embodiment, software implementing the systems and methods described herein can be stored on a storage medium in the computer 1002. Thus, the software can be run from the storage medium in the computer system 1026. Therefore, in this embodiment, the software can be used whether or not computer 1002 is connected to network router 1012. Printer 1008 may be connected directly to computer 1002, in which case, the computer system 1026 can print whether or not it is connected to network router 1012.

With reference to FIG. 11, an embodiment of a special-purpose computer system 1100 is shown. The above methods may be implemented by computer-program products that direct a computer system to perform the actions of the above-described methods and components. Each such computer-program product may comprise sets of instructions (codes) embodied on a computer-readable medium that directs the processor of a computer system to perform corresponding actions. The instructions may be configured to run in sequential order, or in parallel (such as under different processing threads), or in a combination thereof. After loading the computer-program products on a general purpose computer system 1026, it is transformed into the special-purpose computer system 1100.

Special-purpose computer system 1100 comprises a computer 1002, a monitor 1006 coupled to computer 1002, one or more additional user output devices 1130 (optional) coupled to computer 1002, one or more user input devices 1140 (e.g., keyboard, mouse, track ball, touch screen) coupled to computer 1002, an optional communications interface 1150 coupled to computer 1002, a computer-program product 1105 stored in a tangible computer-readable memory in computer 1002. Computer-program product 1105 directs system 1100 to perform the above-described methods. Computer 1002 may include one or more processors 1160 that communicate with a number of peripheral devices via a bus subsystem 1190. These peripheral devices may include user output device(s) 1130, user input device(s) 1140, communications interface 1150, and a storage subsystem, such as random access memory (RAM) 1170 and non-volatile storage drive 1180 (e.g., disk drive, optical drive, solid state drive), which are forms of tangible computer-readable memory.

Computer-program product 1105 may be stored in non-volatile storage drive 1180 or another computer-readable medium accessible to computer 1002 and loaded into memory 1170. Each processor 1160 may comprise a microprocessor, such as a microprocessor from Intel® or Advanced Micro Devices, Inc.®, or the like. To support computer-program product 1105, the computer 1002 runs an operating system that handles the communications of product 1105 with the above-noted components, as well as the communications between the above-noted components in support of the computer-program product 1105. Exemplary operating systems include Windows® or the like from Microsoft® Corporation, Solaris® from Oracle®, LINUX, UNIX, and the like.

User input devices 1140 include all possible types of devices and mechanisms to input information to computer system 1002. These may include a keyboard, a keypad, a mouse, a scanner, a digital drawing pad, a touch screen incorporated into the display, audio input devices such as voice recognition systems, microphones, and other types of input devices. In various embodiments, user input devices 1140 are typically embodied as a computer mouse, a trackball, a track pad, a joystick, wireless remote, a drawing tablet, a voice command system. User input devices 1140 typically allow a user to select objects, icons, text and the like that appear on the monitor 1006 via a command such as a click of a button or the like. User output devices 1130 include all possible types of devices and mechanisms to output information from computer 1002. These may include a display (e.g., monitor 1006), printers, non-visual displays such as audio output devices, etc.

Communications interface 1150 provides an interface to other communication networks and devices and may serve as an interface to receive data from and transmit data to other systems, WANs and/or the Internet 1018. Embodiments of communications interface 1150 typically include an Ethernet card, a modem (telephone, satellite, cable, ISDN), a (asynchronous) digital subscriber line (DSL) unit, a FireWire® interface, a USB® interface, a wireless network adapter, and the like. For example, communications interface 1150 may be coupled to a computer network, to a FireWire® bus, or the like. In other embodiments, communications interface 1150 may be physically integrated on the motherboard of computer 1002, and/or may be a software program, or the like.

RAM 1170 and non-volatile storage drive 1180 are examples of tangible computer-readable media configured to store data such as computer-program product embodiments of the present invention, including executable computer code, human-readable code, or the like. Other types of tangible computer-readable media include floppy disks, removable hard disks, optical storage media such as CD-ROMs, DVDs, bar codes, semiconductor memories such as flash memories, read-only-memories (ROMs), battery-backed volatile memories, networked storage devices, and the like. RAM 1170 and non-volatile storage drive 1180 may be configured to store the basic programming and data constructs that provide the functionality of various embodiments of the present invention, as described above.

Software instruction sets that provide the functionality of the present invention may be stored in RAM 1170 and non-volatile storage drive 1180. These instruction sets or code may be executed by the processor(s) 1160. RAM 1170 and non-volatile storage drive 1180 may also provide a repository to store data and data structures used in accordance with the present invention. RAM 1170 and non-volatile storage drive 1180 may include a number of memories including a main random access memory (RAM) to store of instructions and data during program execution and a read-only memory (ROM) in which fixed instructions are stored. RAM 1170 and non-volatile storage drive 1180 may include a file storage subsystem providing persistent (non-volatile) storage of program and/or data files. RAM 1170 and non-volatile storage drive 1180 may also include removable storage systems, such as removable flash memory.

Bus subsystem 1190 provides a mechanism to allow the various components and subsystems of computer 1002 communicate with each other as intended. Although bus subsystem 1190 is shown schematically as a single bus, alternative embodiments of the bus subsystem may utilize multiple busses or communication paths within the computer 1002.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, and/or various other storage mediums capable of storing that contain or carry instruction(s) and/or data.

Therefore, the present disclosure is well adapted to attain the ends and advantages mentioned as well as those that are inherent therein. While the principles of the disclosure have been described above in connection with specific apparatuses and methods, it is to be clearly understood that this description is made only by way of example and not as limitation on the scope of the disclosure. Furthermore, no limitations are intended to the details of construction or design herein shown, other than as described in the claims below. Also, the terms in the claims have their plain, ordinary meaning unless otherwise explicitly and clearly defined by the patentee. The indefinite articles “a” or “an,” as used in the claims, are defined herein to mean one or more than one of the element that it introduces; and subsequent use of the definite article “the” with respect to the element is not intended to negate that meaning.

1. A venue ticket buyback system to facilitate repurchasing of venue tickets from ticketholders, the venue ticket buyback system comprising:
one or more network interfaces configured to provide access to a network;
one or more processors coupled to the one or more network interfaces to enable a user to select an option for venue ticket buyback through the network, the one or more processors to execute instructions to:
cause indication of the option for venue ticket buyback to the user with at least one of the one or more network interfaces;
process a user selection of the option for venue ticket buyback;
process an identification reference for a venue ticket, the identification reference received from the user;
authenticate the identification reference for the venue ticket with ticket information accessible to the one or more processors;
authenticate the user with authentication information accessible to the one or more processors;
access potential buyer information retained in one or more repositories that comprise profile information for a plurality of potential buyers associated with a secondary marketplace;
determine a potential buyer for the venue ticket out of the plurality of potential buyers based at least in part on the potential buyer information:
determine a buyback price for the venue ticket at least partially based on a profile of the potential buyer, the buyback price having been determined by the potential buyer;
cause indication of the buyback price to the user;
repurchase the venue ticket at the buyback price on behalf of the potential buyer; and
enable the potential buyer to offer the venue ticket for resell via the secondary marketplace; and
one or more storage media coupled to the one or more processors to retain the instructions.

2. The venue ticket buyback system of claim 1, wherein the one or more processors are to execute instructions further to:
identify ticket information indicating one or more attributes corresponding to the venue ticket and/or a corresponding event;
wherein the determining the buyback price for the venue ticket at least partially based on the profile of the potential buyer is further at least partially based on:
comparing one or more items of the profile to one or more items of the ticket information; and
identifying one or more conditions at least partially based on the comparison of the one or more items of the profile to the one or more items of the ticket information.

3. The venue ticket buyback system of claim 1, wherein the one or more processors are to execute instructions further to:
invalidate the identification reference for the venue ticket; and
assign a second identification reference to the venue ticket.

4. The venue ticket buyback system of claim 1, wherein the profile of the potential buyer comprises a notification profile, and wherein the determining the buyback price for the venue ticket at least partially based on the profile of the potential buyer is further at least partially based on:
sending a notification corresponding to the potential buyer; and
processing a response from the potential buyer indicating the buyback price.

5. The venue ticket buyback system of claim 4, wherein the one or more processors are to execute instructions further to:
select the potential buyer based at least in part on a notification hierarchy;
wherein the sending the notification corresponding to the potential buyer is responsive to the selecting the potential buyer based at least in part on the notification hierarchy.

6. The venue ticket buyback system of claim 1, wherein the one or more processors are to execute instructions further to:
process a request from the potential buyer; and
identify the venue ticket as corresponding to the request from the potential buyer.

7. The venue ticket buyback system of claim 6, wherein the presenting the option for venue ticket buyback to the user with at least one of the one or more network interfaces is responsive to the identifying the venue ticket as corresponding to the request from the potential buyer.

8. A method of facilitating repurchasing of venue tickets from ticketholders, the method comprising:
causing indication, by a computer system, of an option for venue ticket buyback to a user with a network interface;
processing, by the computer system, a user selection of the option for venue ticket buyback;
processing, by the computer system, an identification reference for a venue ticket, the identification reference received from the user;
authenticating, by the computer system, the identification reference for the venue ticket with ticket information;
authenticating, by the computer system, the user with authentication information;
accessing, by the computer system, potential buyer information retained in one or more repositories that comprise profile information for a plurality of potential buyers associated with a secondary marketplace;
determining, by the computer system, a potential buyer for the venue ticket out of the plurality of potential buyers based at least in part on the potential buyer information;
determining, by the computer system, a buyback price for the venue ticket at least partially based on a profile of the potential buyer, the buyback price having been determined by the potential buyer;
causing indication, by the computer system, of the buyback price to the user;
repurchasing, by the computer system, the venue ticket at the buyback price on behalf of the potential buyer; and
enabling, by the computer system, the potential buyer to offer the venue ticket for resell via the secondary marketplace.

9. The method of facilitating repurchasing of venue tickets from ticketholders of claim 8, further comprising:
identifying ticket information indicating one or more attributes corresponding to the venue ticket and/or a corresponding event;
wherein the determining the buyback price for the venue ticket at least partially based on the profile of the potential buyer is further at least partially based on:
comparing one or more items of the profile to one or more items of the ticket information; and
identifying one or more conditions at least partially based on the comparison of the one or more items of the profile to the one or more items of the ticket information.

10. The method of facilitating repurchasing of venue tickets from ticketholders of claim 8, further comprising:
invalidating the identification reference for the venue ticket; and
assigning a second identification reference to the venue ticket.

11. The method of facilitating repurchasing of venue tickets from ticketholders of claim 8, wherein the profile of the potential buyer comprises a notification profile, and wherein the determining the buyback price for the venue ticket at least partially based on the profile of the potential buyer is further at least partially based on:
sending a notification corresponding to the potential buyer; and
processing a response from the potential buyer indicating the buyback price.

12. The method of facilitating repurchasing of venue tickets from ticketholders of claim 11, further comprising:
selecting the potential buyer based at least in part on a notification hierarchy;
wherein the sending the notification corresponding to the potential buyer is responsive to the selecting the potential buyer based at least in part on the notification hierarchy.

13. The method of facilitating repurchasing of venue tickets from ticketholders of claim 8, further comprising:
processing a request from the potential buyer; and
identifying the venue ticket as corresponding to the request from the potential buyer.

14. The method of facilitating repurchasing of venue tickets from ticketholders of claim 13, wherein the presenting the option for venue ticket buyback to the user with at least one of the one or more network interfaces is responsive to the identifying the venue ticket as corresponding to the request from the potential buyer.

15. A non-transitory machine-readable medium having machine-readable instructions thereon which, when executed by one or more computers or other processing devices, implements a method of facilitating repurchasing of venue tickets from ticketholders, the method comprising:
presenting an option for venue ticket buyback to a user with a network interface;
processing a user selection of the option for venue ticket buyback;
processing an identification reference for a venue ticket, the identification reference received from the user;
authenticating the identification reference for the venue ticket with ticket information;
authenticating the user with authentication information;
accessing potential buyer information retained in one or more repositories that comprise profile information for a plurality of potential buyers associated with a secondary marketplace;
determining a potential buyer for the venue ticket out of the plurality of potential buyers based at least in part on the potential buyer information;
determining a buyback price for the venue ticket at least partially based on a profile of the potential buyer, the buyback price having been determined by the potential buyer;
indicating the buyback price to the user;
repurchasing the venue ticket at the buyback price on behalf of the potential buyer; and
enabling the potential buyer to offer the venue ticket for resell via the secondary marketplace.

16. The non-transitory machine-readable medium of claim 15, wherein the method further comprises:
identifying ticket information indicating one or more attributes corresponding to the venue ticket and/or a corresponding event;
wherein the determining the buyback price for the venue ticket at least partially based on the profile of the potential buyer is further at least partially based on:
comparing one or more items of the profile to one or more items of the ticket information; and
identifying one or more conditions at least partially based on the comparison of the one or more items of the profile to the one or more items of the ticket information.

17. The non-transitory machine-readable medium of claim 15, wherein the method further comprises:
invalidating the identification reference for the venue ticket; and
assigning a second identification reference to the venue ticket.

18. The non-transitory machine-readable medium of claim 15, wherein the profile of the potential buyer comprises a notification profile, and wherein the determining the buyback price for the venue ticket at least partially based on the profile of the potential buyer is further at least partially based on:
sending a notification corresponding to the potential buyer; and
processing a response from the potential buyer indicating the buyback price.

19. The non-transitory machine-readable medium of claim 18, wherein the method further comprises:
selecting the potential buyer based at least in part on a notification hierarchy;
wherein the sending the notification corresponding to the potential buyer is responsive to the selecting the potential buyer based at least in part on the notification hierarchy.

20. The non-transitory machine-readable medium of claim 15, further comprising:
processing a request from the potential buyer; and
identifying the venue ticket as corresponding to the request from the potential buyer.
